(19) United States
(12) Patent Application Publication
(10) Pub. No.: US 2017/0290366 A1
(43) Pub. Date: Oct. 12, 2017

(54) BITE VALVE FOR HOOKAH HOSE

(71) Applicant: Jared Dipsiner, Oviedo, FL (US)

(72) Inventor: Jared Dipsiner, Oviedo, FL (US)

(21) Appl. No.: 15/096,321

(22) Filed: Apr. 12, 2016

(51) Int. Cl. A24F 1/30; A24F 1/32; F16K 15/14; A24F 7/00

(52) U.S. Cl. CPC A24F 1/30; A24F 7/00; A24F 1/32; F16K 15/147

(57) ABSTRACT

A smoking apparatus is provided. The smoking apparatus includes a hookah. The hookah may include a water jar, a bowl and a body stem running from the bowl into the water jar. First ends of a plurality of hoses may fluidly connect with the water jar. A bite valve may be secured to a second end of each of the hoses. Therefore, a user may bite down on the bite valve and smoke the hookah, while the other hoses remain closed, allowing the user to inhale a larger amount of smoke.

### BACKGROUND OF THE INVENTION

The present invention relates to hookah and, more particularly, to a bite valve for a hookah hose.

A hookah is a single or multi-stemmed instrument for vaporizing and smoking flavored tobacco, called shisha, whose vapor or smoke is passed through a water basin—often glass-based—before inhalation. During a hookah session with more than one person, in order to ensure all participants are able to inhale enough smoke, all participants must cover the hole on their hookah hose besides the one person inhaling. This is to close the air flow coming from each opening for the purpose of ensuring the current user inhales a proper amount of smoke from the hookah. It is normal for a participant to devote one of their hands or to press the opening of their hookah hose against their leg or other parts of their body to keep the hookah hose hole sealed while they are not actively using it.

As can be seen, there is a need for a device that closes off air flow of a hookah hose while not in use.

### SUMMARY OF THE INVENTION

In one aspect of the present invention, a smoking apparatus comprises: a hookah comprising a water jar, a bowl, a body stem running from the bowl into the water jar, and at least one hose comprising a first end fluidly connected to the water jar; and a bite valve comprising a hollow body comprising an inlet end secured to a second end of the at least one hose, and an outlet end, wherein a deformable closure is formed at the outlet end, the deformable closure comprising an end wall and a slit formed therethrough, wherein the slit is biased in a closed position, the deformable closure changing shape when a force is applied against the hollow body to open the slit forming an opening allowing flow from an interior of the hollow body.

In another aspect of the present invention, a method of smoking from a hookah comprises: providing the hookah comprising a water jar, a bowl, a body stem running from the bowl into the water jar, and a plurality of hoses each comprising a first end fluidly connected to the water jar; attaching a bite valve to a second end of each of the plurality hoses, wherein each of the bite valves comprise a hollow body comprising an inlet end secured to the hose and an outlet end, wherein a deformable closure is formed at the outlet end, the deformable closure comprising an end wall and a slit formed therethrough, wherein the slit is biased in a closed position; biting the hollow body of one of the plurality bite valves so that the deformable closure changes shape and the slit opens forming an opening allowing flow from an interior of the hollow body; and inhaling smoke through the bite valve.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded perspective view of an embodiment of the present invention;

FIG. 3 is a detail perspective view of an embodiment of the present invention in a closed position; and

FIG. 4 is a detail perspective view of an embodiment of the present invention in an open position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a bite valve that seals the opening of a hookah hose when not in use. The present invention may include a narrowing stem allowing the bite valve to be inserted or placed on top of all hookah hoses causing a seal for all hookah hose air ways. The bite valve includes a self sealing mouth piece that opens when a user applies pressure to it but remains closed while the user is inactive.

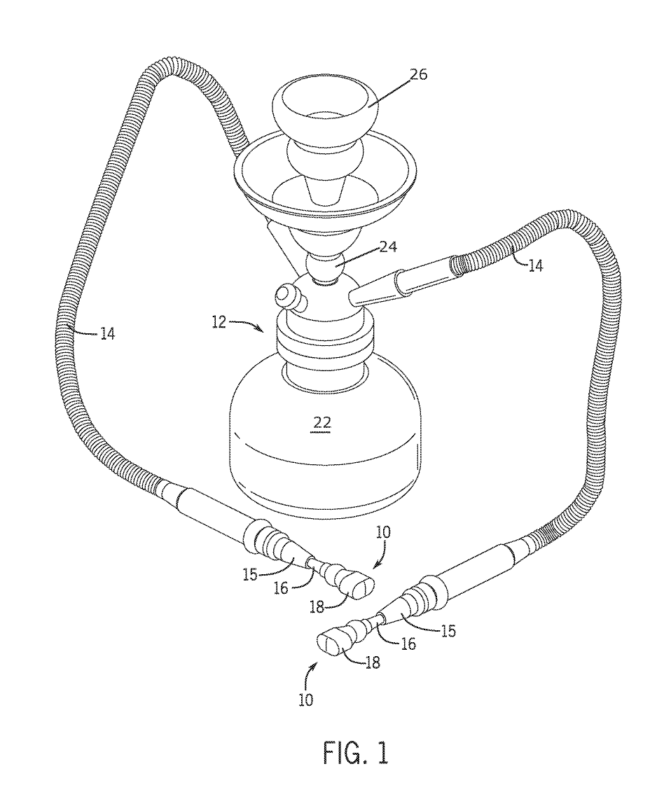

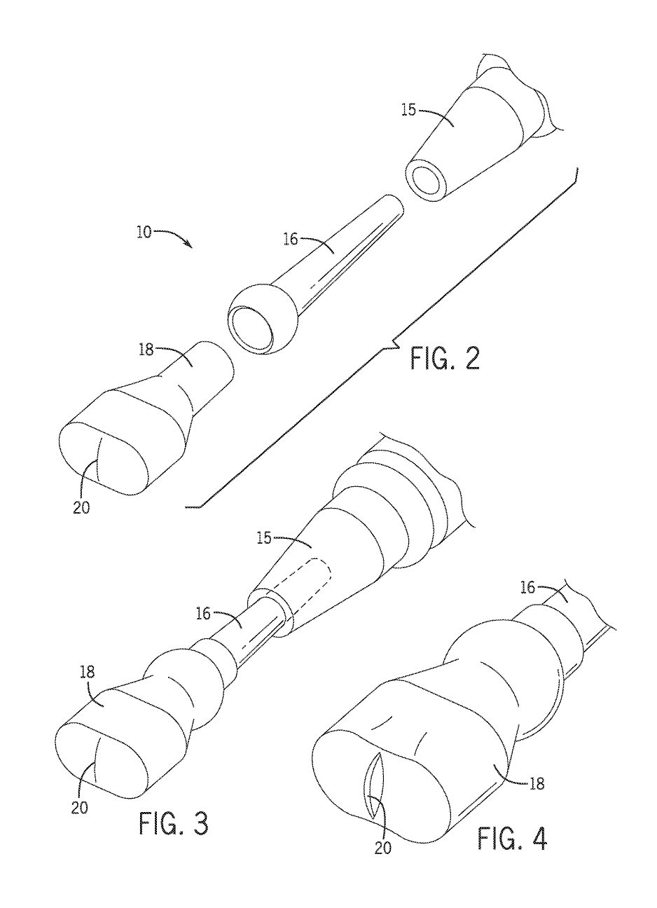

Referring to FIGS. 1 through 4, the present invention includes a smoking apparatus 10. The smoking apparatus 10 includes a hookah 12. The hookah 12 may include a water jar 22, a bowl 26 and a body stem 24 running from the bowl 26 into the water jar 22. First ends of a plurality of hoses 14 may fluidly connect with the water jar 22. A bite valve 18 may be secured to a second end of each of the hoses 14. Therefore, a user may bite down on the bite valve 18 and smoke the hookah 12, while the other hoses 14 remain closed, allowing the user to inhale a larger amount of smoke.

The bite valve 18 of the present invention may be made of a material that has rubber elasticity, such as rubber, silicone, rubber like plastics and the like. The bite valve 18 may be formed of a hollow body having an inlet end and an outlet end. The inlet end may be secured to the second end of the hose 14. A deformable closure may be formed at the outlet end. The deformable closure includes an end wall with a slit 20 formed therethrough. The slit 20 is biased in a closed position. When a user bites down on the sidewall of the hollow body, the deformable closure changes shape and an opening is formed through the slit 20 allowing flow from an interior of the hollow body.

The present invention may further include a hookah stem 16. The hookah stem 16 may be made of a hard plastic or metal. The hookah stem 16 has a hollow core, a first end, and a second end. The hookah stem 16 tapers from the first end to the second end. The second end may include a bulbous portion. The inlet end of the bite valve 18 may deform to secure over the bulbous portion. In such embodiments, the tapered hookah stem 16 is able to fit within the nozzle 15 of almost any hookah hose 14. The bite valve 18 keeps the seal of the hookah hose 14 until a force is applied against the hollow body.

A method of smoking from a hookah may include the following steps: providing the hookah comprising a water jar, a bowl, a body stem running from the bowl into the water jar, and a plurality of hoses each comprising a first end fluidly connected to the water jar; attaching a bite valve to a second end of each of the plurality hoses, wherein each of the bite valves comprise a hollow body comprising an inlet end secured to the hose and an outlet end, wherein a deformable closure is formed at the outlet end, the deformable closure comprising an end wall and a slit formed therethrough, wherein the slit is biased in a closed position; biting the hollow body of one of the plurality bite valves so that the deformable closure changes shape and the slit opens forming an opening allowing flow from an interior of the hollow body; and inhaling smoke through one of the hoses and the bite valve.

It should be understood, of course, that the foregoing relates to exemplary embodiments of the invention and that modifications may be made without departing from the spirit and scope of the invention as set forth in the following claims.

What is claimed is:

1. A smoking apparatus comprising:
a hookah comprising a water jar, a bowl, a body stem running from the bowl into the water jar, and at least one hose comprising a first end fluidly connected to the water jar; and
a bite valve comprising a hollow body comprising an inlet end secured to a second end of the at least one hose, and an outlet end, wherein a deformable closure is formed at the outlet end, the deformable closure comprising an end wall and a slit formed therethrough, wherein
the slit is biased in a closed position, the deformable closure changing shape when a force is applied against the hollow body to open the slit forming an opening allowing flow from an interior of the hollow body.

2. The smoking apparatus of claim 1, wherein the bite valve comprises a rubber elasticity.

3. The smoking apparatus of claim 1, further comprising a hookah stem comprising a hollow core, a first end disposed within a nozzle of the hose, and a second end comprising a bulbous portion, wherein the inlet end of the bite valve secures over the bulbous portion.

4. The smoking apparatus of claim 3, wherein the hookah stem tapers from the bulbous portion to the first end.

5. A method of smoking from a hookah comprising the steps of:
providing the hookah comprising a water jar, a bowl, a body stem running from the bowl into the water jar, and a plurality of hoses each comprising a first end fluidly connected to the water jar;
attaching a bite valve to a second end of each of the plurality hoses, wherein each of the bite valves comprise a hollow body comprising an inlet end secured to the hose and an outlet end, wherein a deformable closure is formed at the outlet end, the deformable closure comprising an end wall and a slit formed therethrough, wherein the slit is biased in a closed position;
biting the hollow body of one of the plurality bite valves so that the deformable closure changes shape and the slit opens forming an opening allowing flow from an interior of the hollow body; and
inhaling smoke through the bite valve.

6. The method of claim 5, wherein the bite valve comprises a rubber elasticity.

7. The method of claim 5, further comprising a hookah stem comprising a hollow core, a first end disposed within a nozzle of the hose, and a second end comprising a bulbous portion, wherein the inlet end of the bite valve secures over the bulbous portion.

8. The method of claim 7, wherein the hookah stem tapers from the bulbous portion to the first end.
